(19) United States
(12) Patent Application Publication
(10) Pub. No.: US 2025/0342428 A1
(43) Pub. Date: Nov. 6, 2025

(54) METHOD FOR DETERMINING AN IMPACT OF A DIFFERENCE BETWEEN TWO PRODUCTION PROCESSES ON A PRODUCT'S CARBON FOOTPRINT

(71) Applicant: BASF SE, Ludwigshafen am Rhein (DE)

(72) Inventors: Steffen KLOSTERHALFEN, Ludwigshafen am Rhein (DE); Olaf HUBER, Ludwigshafen am Rhein (DE); Christopher Alec ANDERLOHR, Ludwigshafen am Rhein (DE); Bastian GRUMBRECHT, Ludwigshafen am Rhein (DE); Claus TEUBER, Ludwigshafen am Rhein (DE); Sergio VICENTE FERRER, Madrid (ES); Omar Osama Mohamed Mohamed ELBADRAWI, Madrid (ES); Nayeli GAST ZEPEDA, Madrid (ES); James H EHLERS, Florham Park, NJ (US); Jorge SANCHEZ - TORIL NICOLAS, Madrid (ES); Muhammad Mehboob NAWAZ, Worms (DE)

(21) Appl. No.: 18/854,303

(22) PCT Filed: Apr. 4, 2023
(86) PCT No.: PCT/EP2023/058888

§ 371 Date: Oct. 4, 2024

(30) Foreign Application Priority Data
Apr. 4, 2022 (EP) 22382321.2

(51) Int. Cl. G06Q 10/0637; G06Q 50/04

(52) U.S. Cl. CPC G06Q 10/06375; G06Q 50/04

(57) ABSTRACT

The present disclosure relates to a system and method for determining an impact of a difference between two production processes on a product carbon footprint, PCF, of a product produced using the production process. The computer-implemented method comprises receiving first production process data comprising information about a first production process for a product, receiving second production process data comprising information about a second production process different to the first production process, determining, based on the first production process data, a first PCF of the product associated with producing the product using, the first production process; determining, based on the second production process data a second of the product associated with producing the product using the second PCF production process, determining the impact of the difference between the first and second production process by comparing the first and second PCF with each other, and outputting the determined impact on the product's PCF.

The present invention relates to a method for monitoring an environmental impact of a product. In particular the present invention generally relates to monitoring and/or controlling a product carbon footprint (PCF) of a product to be produced, and particularly to a computer-implemented method for determining an impact of a difference between two production processes on a PCF, of a product produced using the production process, a corresponding system for determining such impact, the use of such impact in monitoring and/or controlling production of the product, and a non-transitory computer readable data medium storing a computer program including instructions for executing steps of such method.

The significance of climate protection measures is growing rapidly in the perception of the public, regulators and financial investors. Major companies have announced ambitious short-term CO2 reduction targets, including emissions related to purchased raw materials as, for example, required by the Science-Based Targets Initiative (SBTI). Therefore, transparency on product carbon footprints (PCF) and options to reduce the PCF are increasingly demanded.

PCFS are a measure to determine the amount of greenhouse gas emission caused to produce the respective product. PCFs are an important means to achieve a reduction in greenhouse gas emissions if those products with the lowest PCF are chosen for consumption or for further processing downstream in the value chain. For this purpose, it is of high importance that the reported PCF of any product is as accurate as possible.

An environmental impact may be measured by the PCF of the product. PCFs are often calculated by computer programs receiving the required input and subjecting them to an algorithm which calculates the PCF therewith. Thereby, for a linear production chain, i.e., a raw material is processed in multiple processing steps into one single product, this calculation is a straightforward addition of the contributions. However, the calculation of the PCF becomes more difficult if a processing step has more than one output used to produce multiple products. Further, whenever a change in the production process is made or planned usually causes a change in the PCF of the product to be produced. Also, for new factories or even new production sites containing multiple factories, it would be helpful to know as early as possible, e.g. prior to the change of the production process, what the PCF of the product will be. The more complex a production site becomes the less obvious the impact of any change on the downstream product(s) becomes.

There may, therefore, be a need for providing means for early determining the impact of a change to be made or made to a production process on a product carbon footprint (PCF) of the product. The object is solved by the subject-matter of the independent claims, wherein further embodiments are incorporated in the dependent claims.

In a first aspect, there is provided a computer-implemented method for determining an impact of a difference between two production processes on a product carbon footprint (PCF) of a product produced using the production process. The method may be carried out by a suitable system, e.g. the system of the fourth aspect described below, or the like, comprising at least one computing device, processor, or the like, and may be applied to a changing, changed or new, planned production process for producing a product, in e.g. a production plant, production network, or the like.

The method comprises the following steps:
Receiving first production process data comprising information about a first production process for a product.
Receiving second production process data comprising information about a second production process different to the first production process.
Determining, based on the first production process data, a first PCF of the product associated with producing the product using the first production process.
Determining, based on the second production process data, a second PCF of the product associated with producing the product using the second production process.
Determining the impact of the difference between the first and second production process by comparing the first and second PCF with each other; and outputting the determined impact on the product's PCF.

In this way, the impact of the difference between the first production process and the second production process can be determined particularly early, even prior to an actual change of the production process to the second production process, and can be even predicted. The impact can also be used to determine at an early stage, e.g. also as a prediction, the PCF of the product that can be expected as a result of the changed production process. This also allows the planned production process to be evaluated, since the PCF that can be achieved for the product can also be determined at an early stage. Thereby, the difference may be caused by e.g. one or more changes made or to be made to the production process and/or its process parameter(s), such as to the raw material, or generally input material, used to produce the product, or generally the output of the production process, which may also be a part of more complex production process including several individual product processes, raw materials, process steps, intermediates, products, etc. Also, different, especially planned, changes can be weighed against each other, since with relatively little effort different changed production processes, i.e., second production processes as referred to herein, can be assessed with respect to the expected impact on the product's PCF, so that also, for example, the change(s) having the most favorable impact on the PCF can be determined. That is, the method can also be used to control the production process to be optimized in terms of the product's PCF. By using the determined impact of the difference between the first and second production process, the production of the product and/or production process, which may be carried out in e.g. a production plant, multiple production plants which execute interconnected process steps, or the like, can at least be monitored and/or controlled. For example, with the knowledge of the impact on the PCF of the product, it is also possible to control and/or intervene in the production process in order to either improve the production process at least in parts, adjust and/or correct the

PCF of the product, etc. The method can therefore also be used as part of or can be applied to a production control system that can be configured to, for example, control the provision of materials, individual or all process steps for processing one or more input materials into one or more output materials, as well as an intermediate, material procurement, material transport or the like.

In other words, the method, which may be implemented by a computer program including computer instructions which, when executed by a data processor or other suitable computing device, is configured to determine, e.g. calculate etc., the impact on the PCF of one or more products to be produced with the different, second production process based on the first production process data, which can also be only planned or already actually implemented.

For example, the method may optionally further comprise determining the difference between the first production process and the second production process, if the difference is not already apparent from the first and/or second production process data alone or if these do not yet indicate the difference. If there is only one difference between the first and second production process, this single difference may be determined as being responsible for the difference in the PCF of the product. However, if there are several differences between the first and second production process, the method may optionally further comprise determining a relative contribution of the individual differences to the changing PCF. This can be done e.g. by successively, e.g. along the production process, changing the first production process with the first difference, calculating the PCF, then the further difference(s) and PCF, etc. Other possibilities are conceivable, e.g. calculate PCF for the intermediates and determine the influence of the changes upstream in the process and determine the relative contribution of the intermediate in the product to determine the influence of the change on the product.

It is noted that the difference between the first and second production process should preferably not change the product, or at least not significantly. In other words, the product stays substantially unchanged and/or the product may be substantially the same product and/or the product may have substantially the same or similar characteristics or quality. That is, if by means of the first production process a certain first product is produced, by means of the second production process still the at least nearly same or identical product is to be produced, wherein however at least one production process parameter is changed compared to the first production process.

Further, it is noted that the method steps directed to the determination, e.g. calculation, of the first and/or second PCF, of the first and/or second environmental impact and/or the impact of the difference on the product's PCF may be performed by e.g. a suitable data processor or other computing device, which may be operatively connected to an input interface via which the first and/or second production process data may be received. Outputting the determined impact on the product's PCF may be performed by e.g. a suitable output interface, e.g. a data interface, communication interface, etc. It is noted that the method steps of receiving the first and second production process data can be performed in any order or even simultaneously.

As used herein, the determined “impact” of the difference between the first and second production process on the product's PCF can be understood as any kind of difference, in the PCF of the product, in particular calculated or actually achieved, as a result of any conceivable change of the production process, i.e. the second production process, compared to the first production process. The change(s) may affect a variety of production process parameters, wherein it can be change of raw materials, their ratio or processing etc., the energy used in the production process, the replacement of production equipment, a change of supplier, a change in logistics, such as different delivery routes or supply channels, etc., to list just a few, wherein other or different production process parameters are also conceivable to be changed depending on the production process, e.g. its complexity. The impact may be expressed in several ways, e.g. as an absolute or relative change of the product's PCF, a qualitative or quantitative assessment of the change of the PCF, or the like.

Likewise, the “difference” between the first and second production process may comprise any deviation, change, or the like, in at least one production process parameter, or may concern a new design, of the second production process compared to the first production process. As mentioned above, the difference may concern a single or several of, depending on the complexity of the production process, a plurality of production process parameters.

For example, the “production process data”, i.e. the first and/or second production process data, may be received via an interface, e.g. a data interface, communication interface, etc. For example, the production process data may comprise one or more of process data comprising information about the process step(s) from the required raw material, which may also referred to as the input material of the at least one process step under consideration, to the product and/or the output material of the at least one process step. In at least some embodiments, the production process data may further comprise a PCF of each raw material and energy data comprising information about the energy consumption for the at least one process step and/or each process step under consideration. Further, the process data may be received from the production plant. It can be received through an interface from a local or a remote database, or any other suitable data source. Preferably, the production process data may be received through an interface to the ERP system. In this way, the production process data may be received from the ERP system. The ERP system may obtain the information from the production plant. In this case, the process data is received from the production plant via an ERP system. In this way, the process data may be instantly updated once any change in the production plant or its surrounding occurs. Depending on the ERP system “instantly” typically means in less than or equal to one day, preferably less than or equal to six hours, in particular less than or equal to one hour. A typical example of such a change would be that the production plant receives insufficient reagent from a different factory and has to use an external supply instead. Such an external supply usually has a different PCF than the internal intermediate, hence changing the PCF of the product produced in the production plant. Another advantage of an ERP is system is that the data is standardized and validated, i.e. it is reliable and typically does not need further validation.

An “ERP system” in the context of the present disclosure shall have its common meaning. A typical ERP system provides an integrated and continuously updated view of core business processes using common databases maintained by a database management system. ERP systems typically track business resources such as cash, raw materials, production capacity and the status of business commitments: orders, purchase orders, and payroll. The applications that make up the system typically share data across various departments such as those responsible for manufacturing, purchasing, sales, accounting, that provide the data.

As used herein, “outputting” the determined impact may be understood as writing the impact and/or the PCF(s) on a non-transitory data storage medium, display it on a user interface or both. It is also possible to provide the output through an interface to a customer, for example to the customers supply chain system, ERP system or the like. It is also possible to provide the output through an interface to the ERP system of the producer itself from where it can be distributed to where this information is needed.

When the determined impact of the difference on the product's PCF is output onto a user interface, the user interface preferably uses graph technology. In this way, it is possible to analyze the contributions along the production process in order to monitor/and or control the production process and thereby minimize the PCF for the products. It is also possible to monitor and/or control changes of the PCF upon changes in the production process. In addition, the output can be used to simulate effects of changes, for example by manually changing certain values and see its effect on the PCF of the product. For example, the effect of replacing a particular raw material by one having lower PCF for each product may be analyzed.

Further, as used herein, the term “carbon footprint (PCF)” may be understood as a total amount of greenhouse gases emitted or removed in the whole process from extracting natural resources to the product as it leaves a production plant. An environmental impact of a product may be measured as a PCF. In the context of the present disclosure, the PCF does not include any greenhouse gas emission later on in the lifetime of a product. For example, for a car, the PCF in the context of the present disclosure is the amount of greenhouse gases emitted to produce the car, but not the emissions caused by using the car once it has left the production plant. The amount of the PCF is typically expressed as carbon dioxide equivalents, so the amount of carbon dioxide with the same effect on global climate as the actually emit-ted greenhouse gases.

Greenhouse emissions and/or gases may comprise carbon dioxide, carbon monoxide, nitrous oxide, methane, ozone, chlorofluorocarbons, hydrofluorocarbons. These can be translated into carbon dioxide equivalents according to IPCC 5th assessment report (cf. standards such as ISO 14067 for carbon footprint of products or the Greenhouse Gas Protocol Product Standard WRI & WBCSD, 2011).

The method described herein can be applied to a wide variety of products which are produced from raw materials. The term “product” as used herein, generally refers to any good which can be sold to others at any point in the value chain. This may include final products and/or finished products for end consumers, for example cars, paints, toys or medicaments; this may also include goods, in particular finished goods, which are typically sold to other companies which further process them, for example steel parts for machines, plastic pellets for extrusion or chemical compounds, for example acrylic acid to produce superabsorbers for diapers; this may also include goods very early in the value chain like crude oil fractions, for example naphtha, agricultural products, for example soy beans, or purified sand for glass production.

The term “raw material” as used in the present disclosure refers to any good which is bought from suppliers and brought to the production plant. A raw material can be on any step along the value chain like the product described above. This means, the product of the one production plant can be the raw material of the other production plant. Raw material can also include very fundamental goods like air, water, natural gas or salt.

An “intermediate” refers to a good, such as a substance, which is neither a raw material nor a product, but is made from raw materials or earlier intermediated and is processed further into other intermediates and finally into the product. The intermediate may be associated with a corresponding process step in which it is produced, used, transported, etc.

A “production plant” as used in the present disclosure is any facility which is able to produce any kind of good which is sold to an end customer or further processed in a different production plant. A production plant can be on one single site or on multiple. If the production plant is in multiple sites, these have to be under common control which is typically the case if they belong to the same company or to affiliated companies. Examples for plants are power plants, steel manufacturing plants, oil producing plants, oil refineries, chemical plants, plants for manufacturing pharmaceuticals, plants for manufacturing construction materials, machine manufacturing plants, automobile manufacturing plants, plants for manufacturing textiles, plants for manufacturing furniture, food production plants, plants for manufacturing consumer electronics such as cell phones, plants for manufacturing and/or processing of paper, such as a printing press.

A “process step” as used herein may be understood as a series of acts onto the raw material(s) which cannot be reasonably separated in time or space. Typically, all acts of one process step take place in one building using a certain dedicated equipment. A “production process” as used herein may be understood as a generally standardized workflow in which a saleable product, or generally output material, is produced or manufactured using specified producing or manufacturing processes, production equipment and operating resources by means of mechanical, electrical, chemical and/or manual processing of raw material, intermediate, etc.

The method according to the present invention is particularly useful for production plants which execute interconnected process steps. The term “interconnected” in the context of the present in invention means that at least one process step uses two intermediates of different other process steps or uses one intermediate of different other process steps each producing this intermediate or yields two intermediates which are used in two different other process steps. Hence, preferably, the production plant executes interconnected process steps. Even more preferably, the production plant is a chemical production plant executing interconnected process steps. Often, the interconnected process steps are executed in different factories, maybe on different sites, potentially operated by different group companies.

According to an embodiment, the method may be carried out prior to an actual implementation of the second production process within a production planning phase. For example, the determined impact of the difference between the first and second production process may first be used only to estimate or predict the impact of a change or new design of the production process on the PCF of the product, in particular of substantially the same product, even before the changed or newly designed production process is actually changed or implemented, e.g. used as a replacement for a previously used or planned production process. In this way, the production process can be checked for the impact of the change in the production process without immediate impact on the actual or ongoing production process and/or the PCF of the product(s). The change may relate to the materials and/or to the structure of the process.

In an embodiment, the second production process may comprise an extension of the production process of the and/or a change in at least one production step or any other production process parameter compared to the first production process. For possible production process parameters that can be changed, reference is made to their description above. The extension may concern an extension by another raw material or the like. Thereby, any expansion and/or change in the production process can be determined or predicted at an early stage in terms of its impact on the PCF of the product.

According to an embodiment, the impact of the difference between the first and second production process on the product's PCF may be output via a user interface. The user interface may comprise a graphical user interface configured to represent the impact of the difference and/or change between the first and second production process in a comprehensible context with the production process, or both production processes, at least one process step thereof, the PCF of the product and/or the monitoring and/or controlling of the production process. For example, the user interface may output, e.g. display, the absolute or the relative change of the PCF for the product caused. Hence, the impact of the difference between the two production processes on the PCF for the product can be visualized and/or evaluated.

In an embodiment, the second production process data may be received via a user interface configured to allow the user, starting from the first production process, and/or the first production process data, to make a change and/or extension to it to obtain the second production process data. For example, the user interface may comprise a graphical user interface (GUI), via which a user, e.g. an operator of the production process, can at least select the a change and/or extension to be made. It may also allow to modify an existing or planned production process, e.g. the first production process and/or first production process data, into the second production process and/or production process data, which differs in at least one production process parameter from the first production process. This allows a wide monitoring and/or wide control of the production process.

According to embodiment, the user interface may be configured for providing the user with a selection of production process and/or product modifications as a blueprint or reference from which a change to the first production process can be selected to obtain the second production process data. For example, the selection may comprise production process data for certain factories which exist already at other sites. These may be combined in a modular way, so not every detail has to be set up from scratch. However, the user interface may allow for adjusting details of the production process as even the same factory built at a new site may differ in some respects. This facilitates production planning and/or implementation.

In an embodiment, the method may further comprise checking the first production process data and/or second production process data for consistency, particularly checking for a closed production chain. For example, the consistency check may comprise checking whether raw material ordered for a site is actually used in at least one production step. Also, it may be checked whether there is no “open end”, i.e., an intermediate is not used in any further process step or a process step uses an intermediate which is not produced in another place in the production process or network. Also, the amounts of raw material and intermediates as well as the products may be used for a validation. In this way, there is provided some validation for the input data, e.g. the production process data etc., to make sure no erratic values are obtained due to subtle errors or the like.

According to an embodiment, the method may further comprise adjusting the first production process data and/or second production process data based on the checking for consistency. For example, if there is detected an inconsistency in the production process and/or production process data, there may be determined a (counter-)measure to fix the inconsistency. For example, if the inconsistency is due to an “open end”, i.e., an intermediate is not used in any further process step or a process step uses an intermediate which is not produced in another place in the production process or network or due the amount or ratio of input material, e.g. raw material, output material and/or intermediate, there may be determined, by, for example, an optimization algorithm or the like, an appropriate (counter-) measure, which e.g. closes the open end, adjusts the amount or ratio of materials, or the like. In this way, production process planning and/or implementation can be further supported.

In an embodiment, the method may further comprise additionally comparing the a second PCF to at least one reference PCF used as a PCF target value, and adjusting the first production process data and/or second production process data based on the comparison with the at least one reference PCF. In other words, the method, e.g. the computer program, may be configured to estimate which production process comes closest to reality, e.g. by comparing at least the second PCF to the reference PCF, e.g. to a market's standard or the like. If the computer program has these as an input, it may be able to output, e.g. display, the deviations. For example, the reference PCF may, for example, be a PCF standardized for the product or a product group contained therein or a PCF customary in the market, e.g. also a PCF of a competitor's product, a PCF specified in some other way, or of the like. This allows the PCF of the product to be monitored and/or controlled even more accurately, or the production process planning and/or implementation to be further supported.

According to an embodiment, the method may further comprise determining a ratio between an individual difference between the first and second production process and an extend of production equipment adjustments associated with the difference between the first and second production process. In other words, the effort or extend and benefit of an change and/or extension of the production process may be determined and/or estimated, particularly in terms of the PCF achievable for the product. This may also include comparing the cost of the amendment and/or expansion of the production process to the PCF of the product that can be achieved by it. This means that an amendment and/or expansion of the production process can also be sorted out or preferred, taking into account the effort and/or extend involved.

In an embodiment, the first PCF and/or the PCF may be determined by receiving a PCF of raw material used for producing the product, receiving energy data comprising information about an energy consumption for each production process step, and calculating the one first PCF and/or second PCF of the product taking into account the fist and/or second production process data, the PCF of raw material and the energy data.

For example, calculating the PCF of the product or the intermediate comprises summing the PCFs of each raw material used in a particular process step as contained in the production process data. If a process step requires an intermediate from a different process step, the sum of the car-bon footprint of the raw material for this earlier process step is determined and used as input for the later process step. It may be necessary to repeat this if the earlier process step again uses an intermediate of an even earlier process step. If one process step yields more than one intermediate, for example two or three, it is necessary to share the PCF of the raw materials among these intermediates. The share for each intermediate should reflect the raw material us-age for each intermediate. In some cases, two intermediates are formed at the same amount, so the PCF of the raw materials can be equally shared among them. In other cases, significantly more of one intermediate is formed than the other, for example 90% of intermediate 1 and 10% of intermediate 2. The PCF should be shared accordingly. Hence, preferably, in the method of the present invention determining the PCF involves calculating the PCF for an intermediate produced in a preceding process step and using the car-bon footprint of the intermediate as input for the calculation of the PCF of a subsequent process step. In particular, in interconnected production processes, the calculation of the PCF can be facilitated by subdividing it into analogous calculation parts, one for each process step.

The production process data may comprise information about which by-products are obtained in which amount. Some process steps may not produce any by-products, such as the assembly of steel parts. In this case, the production process data does not comprise information about by-products. However, many process steps produce by-products. A “by-product” in the context of the present disclosure refers to any good which is unavoidably obtained in a process step but cannot be used in a different process step. Sometimes, a by-product can be recycled, i.e. be subjected to another process step or multiple process steps to obtain a raw material or an intermediate which can be used as reagent in a process step. However, in some cases, there is no economically feasible use for the by-product. In this case, the by-product has to be disposed. It can, for example, be burned in an incineration. If the incineration is part of the production plant, the thermal and/or electrical energy regained has to be taken into account.

The production process data may comprise information about which intermediate or intermediates are obtained in each process step and at which yield. The “yield” in the context of the present invention refers to the percentage of outcome from a particular process step relative to the theoretical maximum. If the yield is 100%, for example if ingredients are mixed into a formulation, the production process data does not have to comprise information about the yield. However, the yield can be below 100% if there are losses in a process step. In chemical reactions, the yield is typically below 100%, be-cause of side reactions and losses upon purifications. In other processes, yields can also be be-low 100%, for example if steel parts are cut or drilled, the chips may cause a loss unless they can be reused.

The production process data may comprise information about any direct greenhouse gas emissions by the process step. Such direct greenhouse gas emissions often stem from a chemical reaction of the raw materials which either contain greenhouse gases or generate greenhouse gases during the process step, for example by heating. A typical example is cement production in which carbon dioxide evolves from heating the raw materials, in particular from heating limestone. The information about direct greenhouse gas emissions usually contains the information which green-house gas is emitted at which amount. The amount can be given relative to the amount of raw materials or relative to the amount of product or intermediate of the respective process step. The latter can be derived from the former by multiplying with the yield of the process step.

In the easiest case, one or multiple raw materials may be processed in one process step to arrive at the product. An example could be that certain cables and plugs are the raw materials which are assembled to form a cable tree as a product which is sold to car manufacturers. In most cases, however, the production processes are more complicated. Multiple raw materials are processed into various intermediates which are processed into various products, wherein one raw material can be used to produce more than one intermediate and one intermediate may be used to pro-duce more than one product. In such a situation, the final PCF of one product become dependent on the amount of other products produced at the production plant. Hence, typically the production process data comprise the information which reagents are required at which amounts for each process step for all products having at least one reagent or intermediate in common. For many production plants, the production process data comprise the information which reagents are required at which amounts for each process step for at least two products having at least one reagent or intermediate in common. For complex production plants the production process data comprise the information which reagents are required at which amounts for each process step for at least five or at least ten products having at least one reagent or intermediate in common.

The production process data is typically obtained, received, etc. through an interface, e.g. a data interface, communication interface, etc. The production process data may be obtained from e.g. a production plant. It can be obtained through an interface to a local or a remote database. Preferably, the production process data is obtained through an interface to an enterprise resource planning (ERP) system. In this way, the production process data may be obtained from the ERP system. The ERP system may obtain the information from the production plant. In this case, the production process data is obtained from the production plant via an ERP system. In this way, the production process data is instantly updated once any change in the production plant or its surrounding occurs. Depending on the ERP system “instantly” typically means in less than or equal to one day, preferably less than or equal to six hours, in particular less than or equal to one hour. A typical example of such a change would be that the production plant receives insufficient reagent from a different factory and has to use an external supply instead. Such an external supply usually has a different PCF than the internal intermediate, hence changing the PCF of the product produced in the production plant. Another advantage of an ERP is system is that the data is standardized and validated, i.e. it is reliable and typically does not need further validation.

According to an embodiment, the method may further comprising implementing the second production process and/or second production process data in the product's production, preferably when meeting a implementation criterion, such as if a better, in particular lower, PCF is achieved, or a favorable cost/benefit ratio is given, or the like. For example, implementation can be performed via production control, ERP system, etc.

A second aspect relates to the use of an impact of a difference between two production processes on a PCF, PCF, of a product, of one product and/or of substantially the same product, wherein the impact is determined by the method of the first aspect, in monitoring and/or controlling production of the product. For example, the particular impact can be used in production process planning and/or implementation, wherein it can be used to control the PCF of the product. For other potential use, reference is made to the remaining description. In a third aspect, there is provided a non-transitory computer readable data medium storing a computer program including instructions for executing steps of the method according to the first aspect. Computer readable data medium include hard drives, for example on a server, USB storage device, CD, DVD or Blue-ray discs. The computer program may contain all functionalities and data required for execution of the method according to the first aspect, or it may provide interfaces to have parts of the method processed on remote systems, for example on a cloud system.

According to a fourth aspect, there is provided a system for determining an impact of a difference between two production processes a PCF, PCF, of a product produced using the production process. The system may be configured to carry out the method of the first aspect.

The system comprises an input interface that is configured to receive first production process data comprising information about a first production process for a product and second production process data comprising information about a second production process different to the first production process. The system further comprises a processor that is configured to determine, based on the first production process data, a first PCF of the product associated with producing the product using the first production process, determine, based on the second production process data, a second PCF of the product associated with producing the product using the second production process, and determine the impact of the difference between the first and second production process by comparing the first and second PCF with each other. Further, the system comprises an output interface that is configured to output the determined impact on the product's PCF.

According to an embodiment, the output interface may comprise a user interface that is at least configured to display the determined impact on the product's PCF for further processing. The user interface is preferably configured to display the determined impact and/or PCF of the product and each contribution, preferably comprising the contribution of the raw materials, the contribution of the energy, and the contribution of the direct emissions of each process step. Preferably, the user interface uses graph technology. The user interface may provide an overview of each process step, its raw materials and energy required, the connection with other process steps. The user interface may also provide the

PCF for each process step, in particular it may display the PCF originating from the raw materials, from the energy consumption, and from the direct greenhouse gas emissions separately and in aggregated form.

It is noted that embodiments of the invention are described with reference to different subject-matters. In particular, some embodiments are described with reference to method-type claims whereas other embodiments are described with reference to apparatus or device-type or system-type claims. However, a person skilled in the art will gather from the above and the following description that, unless otherwise notified, in addition to any combination of features belonging to one type of subject-matter also any combination between features relating to different subject-matter is considered to be disclosed with this application. Further, all features can be combined providing synergetic effects that are more than the simple summation of the features.

These and other aspects of the present disclosure will become apparent from and elucidated with reference to the embodiments described hereinafter.

Exemplary embodiments of the invention will be described in the following with reference to the following drawings.

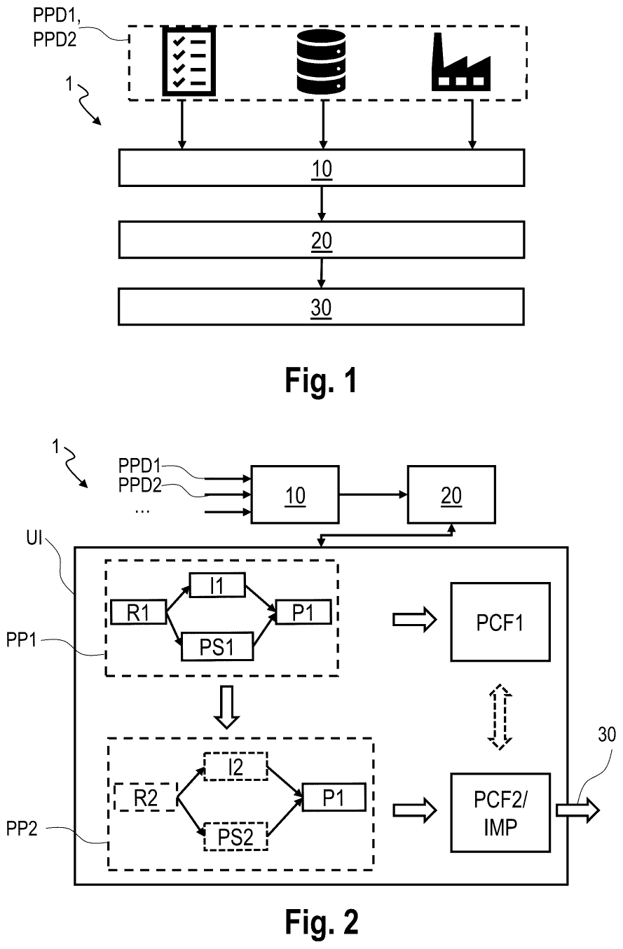

FIG. 1 illustrates in a schematic block diagram a system for determining an impact of a difference between two production processes on a product carbon footprint (PCF) according to the present disclosure.

FIG. 2 illustrates in a schematic block diagram a system and principle for determining an impact of a difference between two production processes on a product carbon footprint (PCF) according to the present disclosure.

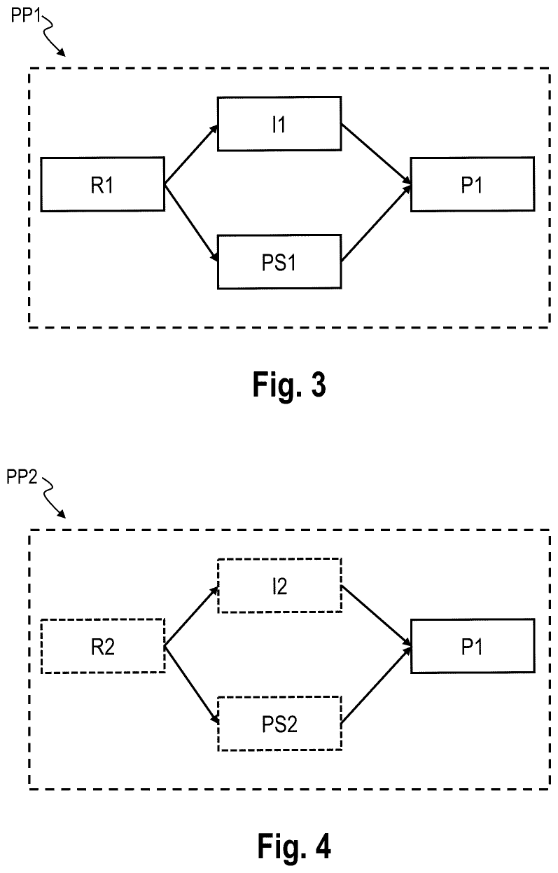

FIG. 3 illustrates in a schematic block or process diagram an example of a production process or production chain planned or used for producing a product.

FIG. 4 illustrates in a schematic block or process diagram the example of a production process or production chain planned or used for producing a product of FIG. 3 with a difference within the production process compared to that of FIG. 3.

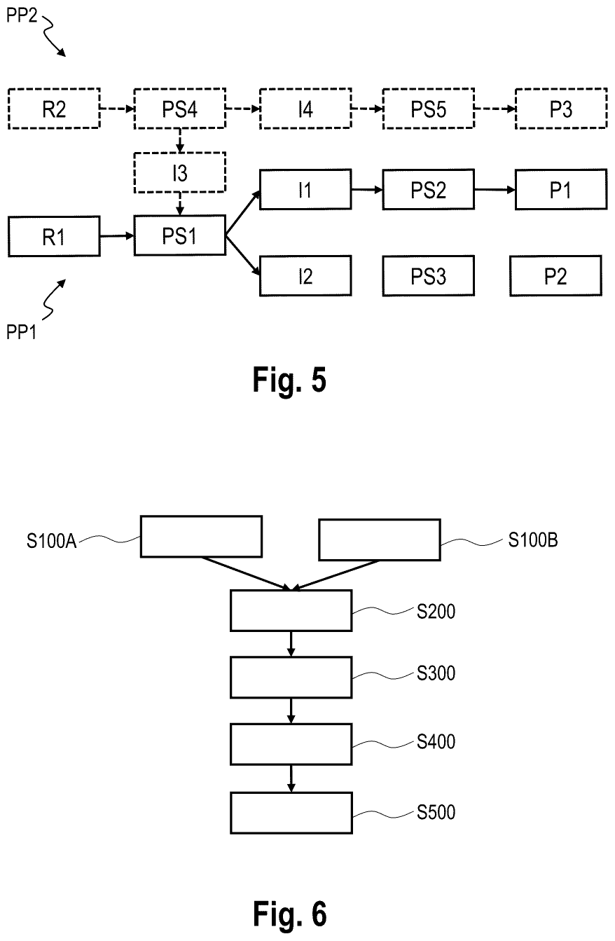

FIG. 5 illustrates in a schematic block or process diagram an example of a production process or production chain for producing a product with a difference within the production process.

FIG. 6 illustrates in a flow chart a computer-implemented method for system for determining an impact of a difference between two production processes on a product carbon footprint (PCF) according to the present disclosure.

The drawings are merely schematic representations and serve only to illustrate the invention. Identical or equivalent elements are consistently provided with the same reference signs.

FIG. 1 illustrates in a schematic block diagram a system 1 that is configured to determine an impact IMP (see e.g. FIG. 2) of a difference between two production processes PP1, PP2 (see e.g. FIG. 2 to FIG. 5) on a product carbon footprint (PCF) of a product P1, P2, P3 (see e.g. FIG. 2 to FIG. 5) produced using the production process PP1, PP2), which may also be referred to as production chain. The system 1 is any suitable computing device and comprises an input interface 10, a data processor 20, and an output interface 30. The processor 20 is operatively connected to each one of the input interface 10 and the output interface 30.

The input interface 10 is e.g. a data interface, communication interface, or the like, configured to receive first production process data PPD1 (see e.g. FIG. 2) comprising information about a first production process PP1 for a product and second production process data PPD2 (see e.g. FIG. 2 to FIG. 5) comprising information about a second production process PP2 different to the first production process PP1. For this purpose, the input interface 10 is operatively connected to, for example, one or more suitable data sources, such as an enterprise resource planning system (ERP), a supplier database, a production controller, or the like, which may collect and/or provide process data PPD, such as the first and second production process data PPD1, PPD2. For example, the process data PPD may comprise one or more of process data comprising information about the process steps from the required raw materials to the product, a PCF of each raw material, and energy data comprising information about the energy consumption for each process step. The first and second point in time may be two different points in time within the production process, different links in the production chains, or the like.

The processor 20 is configured, e.g. by executing computer instructions of a respective computer program, to determine, based on the first production process data PPD1 (see e.g. FIG. 2), a first PCF1 of the product P1, P2, P3 associated with producing the product P1, P2, P3 (see e.g. FIG. 2 to FIG. 5) using the first production process PP1. The processor 20 is further configured to determine, based on the second production process data PPD2, a second PCF2 of the product associated with producing the product using the second production process PP1. Further the processor 20 is configured to determine the impact IMP (see FIG. 2) of the difference between the first and second production process PP1, PP2 by comparing the first and second PCF1 PCF2 with each other.

The output interface 30 is any suitable data interface, communication interface or the like, configured to output the determined impact IMP on the product's PCF for further processing. For example, the output interface 30 may, for example, comprise or may be operatively connected to a user interface UI (see e.g. FIG. 2) for displaying the determined impact IMP on the product's PCF the determined impact IMP on the product's PCF. However, it may also be operatively connected to a production control system (not shown), the ERP (not shown) or the like, so that the system 1 may monitor and, particularly computationally, control the production based on the determined impact IMP on the product's PCF, e.g. for planning, implementing and/or controlling the production process. The control of the production process may comprise, for example, controlling one or more parameters of the production process, such as raw material, energy consumption, etc., thereby also controlling the PCF of the product P1, P2, P3 accordingly.

It is noted that the processor 20 and/or output interface 30 may be operatively connected to a production control system, the ERP, or the like, and configured to output one or more control signals configured to control the production control system, the ERP, the supply chain, etc.

Optionally, the processor 20 is configured to determine the impact IMP of the difference between the first production process PP1 and the second production process PP2 prior to an actual implementation of the second production process PP2 within a production planning phase.

Further optionally, the processor 20 is configured to determine the first PCF1 and/or the second PCF may be determined by receiving a PCF of raw material used for producing the product, receiving energy data comprising information about an energy consumption for each production process step, and calculating the one first PCF and/or second PCF of the product taking into account the fist and/or second production process data, the PCF of raw material and the energy data.

For example, calculating the PCF of the product or the intermediate comprises summing the PCFs of each raw material used in a particular process step as contained in the production process data. If a process step requires an intermediate from a different process step, the sum of the carbon footprint of the raw material for this earlier process step is determined and used as input for the later process step. It may be necessary to repeat this if the earlier process step again uses an intermediate of an even earlier process step. If one process step yields more than one intermediate, for example two or three, it is necessary to share the PCF of the raw materials among these intermediates. The share for each intermediate should reflect the raw material us-age for each intermediate. In some cases, two intermediates are formed at the same amount, so the PCF of the raw materials can be equally shared among them. In other cases, significantly more of one intermediate is formed than the other, for example 90% of intermediate 1 and 10% of intermediate 2. The PCF should be shared accordingly. Hence, preferably, in the method of the present invention determining the PCF involves calculating the PCF for an intermediate produced in a preceding process step and using the car-bon footprint of the intermediate as input for the calculation of the PCF of a subsequent process step. In particular, in interconnected production processes, the calculation of the PCF can be facilitated by subdividing it into analogous calculation parts, one for each process step.

FIG. 2 illustrates in a schematic block diagram the system 1 described above and the principle determining, via the input interface 10, the processor 20 and the output interface 30, the impact IMP of a difference between two production processes PP1, PP2 on a PCF, PCF, of a product P1 produced using the first and/or second production process PP1, PP2.

It is noted that the first production process PP1 may be a planned or actually existing production process, or a kind of template, blueprint, reference or the like, but forms a starting point or the basis for the comparison of the two production processes PP1 and PP2. The first production process PP1 is indicated by solid lines in FIG. 2.

Further, it is noted that the second production process PP2 may be a planned or newly designed production process. The second production process PP2 is indicated by dashed lines in FIG. 2, representing exemplary changes to be made to such a production process.

For example, the production process PP1 for product P1 starts from a raw material R1 using a production process PS1 via an intermediate I1, an intermediate I2, and a further raw material R2. In this example, the production process PP runs in the direction of the arrows connecting the individual process elements, wherein the products P1 is produced at the end. As indicated in FIG. 2 by the designation UI, the user interface UI, which may be comprised or may form the output interface 30, can be configured to output, e.g. display, the first PCF designated as PCF1 and the second PCF2 designated as PCF2, as well as the impact IMP of the difference between the first production process PP1 and the second production process PP2. Further, as indicated in FIG. 2 by the arrow 30, the output interface 30 may also be connected to further processing means, such as the production control system, ERP system, or the like, in order to actively control the production process and/or to control the PCF of the product P1.

In contrast thereto, the production process PP2 for product P1 is different to the above first production process P1, since one or more of the process parameters indicated by dashed lines may be changed compared to the above first production process PP1. Merely exemplary, the raw material may be changed to R2, the intermediate may be changed to 12, the process step may be changed to PS2, wherein the process parameters are not limited herein. Although not shown in FIG. 2 (but in e.g. FIG. 4), the second production process PP2 may also differ from the first production process PP1 by an extension of the production process. For example, the user interface UI may output, e.g. display, the absolute or the relative change of the PCF for the product P1, which may be an example of an indicator for the impact of the difference between the first and second production process PP1, PP2.

Both production processes PP1 and PP2 produce a product, one product and/or substantially the same product. In other words, both production processes PP1 and PP2 produce a product having substantially the same and/or similar characteristics.

Optionally, the second production process data PPD2 may be received via the user interface UI that is optionally configured to allow the user, starting from the first production process PP1, and/or the first production process data, to make a change and/or extension to it to obtain the second production process data PP2. These data may then be provided to the processor 20 to perform the determination of the first PCF1 and second PCF2, etc. For example, the user interface UI may comprise a graphical user interface (GUI), via which the user, e.g. an operator of the production process, can at least select the a change and/or extension to be made to the production process, i.e. the first production process PP1. It may also allow to modify an existing or planned production process, e.g. the first production process and/or first production process data, into the second production process and/or production process data, which differs in at least one production process parameter from the first production process.

Further optionally, the user interface UI may be configured to providing the user with a selection of production process and/or product modifications as a blueprint or reference from which a change to the first production process can be selected to obtain the second production process data. For example, the selection may comprise production process data for certain factories which exist already at other sites. These may be combined in a modular way, so not every detail has to be set up from scratch. However, the user interface may allow for adjusting details of the production process as even the same factory built at a new site may differ in some respects.

Further optionally, the processor 20 is configured to check the first production process data PP1 and/or second production process data PP2 (see e.g. FIG. 2) for consistency, particularly to check for a closed production chain. For example, the consistency check may comprise checking whether raw material ordered for a site is actually used in at least one production step. Also, it may be checked whether there is no “open end”, i.e., an intermediate is not used in any further process step or a process step uses an intermediate which is not produced in another place in the production process or network. Also, the amounts of raw material and intermediates as well as the products may be used for a validation.

Optionally, the processor 20 and/or the output interface 30 is configured to adjust the first production process data PPD1 and/or second production process data PPD2 based on the check for consistency. For example, if there is detected an inconsistency in the production process and/or production process data, there may be determined a (counter-)measure to fix the inconsistency. For example, if the inconsistency is due to an “open end”, i.e., an intermediate is not used in any further process step or a process step uses an intermediate which is not produced in another place in the production process or network or due the amount or ratio of input material, e.g. raw material, output material and/or intermediate, there may be determined, by, for example, an optimization algorithm or the like, an appropriate (counter-)measure, which e.g. closes the open end, adjusts the amount or ratio of materials, or the like.

Further optionally, the processor 20 is configured to additionally compare the second PCF2 to at least one reference PCF used as a PCF target value, and adjusting the first production process data and/or second production process data based on the comparison with the at least one reference PCF. In other words, the method, e.g. the computer program, may be configured to estimate which production process comes closest to reality, e.g. by comparing at least the second PCF to the reference PCF, e.g. to a market's standard or the like. If the computer program has these as an input, it may be able to output, e.g. display, the deviations. For example, the reference PCF may, for example, be a PCF standardized for the product or a product group contained therein or a PCF customary in the market, e.g. also a PCF of a competitor's product, a PCF specified in some other way, or of the like.

FIG. 3 illustrates in a schematic block or process diagram an example of the production process PP1 or production chain. as described above. In this simple production process, one raw material R1 is processed to one intermediate I1 and by one process step PS1 combined to a product P1. This production process PP1 can be a planned production process only, e.g. virtual production process, or a production process actually already implemented and used for the production of the product P1. This can be modified in many ways, as described below, such as by changing the raw material R1, the process step PS1 or the intermediate I1.

As already described above with reference to FIG. 2, production process PP1 forms at least a basis for comparison with production process PP2, but can also be a template for the latter, from which changes, extensions, etc. to the production process can then be made.

FIG. 4 illustrates in a schematic block or process diagram an example of the production process PP2 or production chain, which is different to the production process PP1 illustrated in FIG. 3. As already described above with reference to FIG. 2, the production process PP2 for product P1 is different to the above first production process P1, since one or more of the process parameters indicated by dashed lines may be changed compared to the above first production process PP1. Merely exemplary, the raw material may be changed to R2, the intermediate may be changed to I2, the process step may be changed to PS2, wherein the process parameters are not limited herein.

It is noted that the product P1 is deliberately shown with a solid line because, preferably, although the second production process PP2 has a difference from the first production process PP1, it is intended to produce the same product P1.

FIG. 5 illustrates in a schematic block or process diagram another example of a production process PP or production chain in which there are several changes, which are indicated by dashed lines, to be made or made to the production process PP1, which is indicated by solid lines. FIG. 5 thus shows an extension of an exemplary first production process PP1 to an exemplary second production process PP2.

In this example, the solid boxes indicate the existing production process PP1. A raw material R1 is processed in process step PS1 into the two intermediates I1 and I2 which are further processed into the products 1 and 2. Now it is planned to extend the production network by producing a portion of raw material R1 internally. The boxes with the broken lines indicate this extension. The newly required raw material R2 is processed in process step PS4 into intermediate I3 which is the same as raw material R1. Process step 4 produces another intermediate, namely 14, which is further processed into product 3.

Optionally, processor 20 is further configured to determine a ratio between an individual difference between the first and second production process and an extend of production equipment adjustments associated with the difference between the first and second production process. In other words, the effort or extend and benefit of an change and/or extension of the production process may be determined and/or estimated, particularly in terms of the PCF achievable for the product. This may also include comparing the cost of the amendment and/or expansion of the production process to the PCF of the product that can be achieved by it. This means that an amendment and/or expansion of the production process can also be sorted out or preferred, taking into account the effort and/or extend involved.

FIG. 6 illustrates in a flow chart a computer-implemented method for determining an impact IMP of a difference between two production processes PP1, PP2 on a PCF (PCF) of a product P1, P2, P3) produced using the production process PP1, PP2. The method may be carried out by the system 1 as described above and/or may be applied to the exemplary production processes shown in FIG. 3, FIG. 4 or FIG. 5, in order to determine the at least one impact IMP.

In a step S100A, there is received first production process data PPD1 comprising information about a first production process PP1 for a product P1, P2, P3. For example, the first production process data PPD1 may be received by the processor 20 via the input interface 10, as described above.

In a step S100B, there is received second production process data PPD2 comprising information about a second production process PP2 different to the first production process PP1. For example, the second production process data PPD2 may be received by the processor 20 via the input interface 10, as described above.

In a step S200, there is determined, based on the first production process data (PPD1), a first PCF1 of the product P1, P2, P3 associated with producing the product P1, P2, P3 using the first production process PP1. This determination may be performed by the processor 20, as described above.

In a step S300, there is determined, based on the second production process data PPD2, a second PCF2 of the product P1, P2, P3 associated with producing the product P1, P2, P3 using the second production process PP1. This determination may be performed by the processor 20, as described above.

In a step S400, there is determined the impact IMP of the difference between the first and second production process PP1, PP2 by comparing the first PCF1 and second PCF2 with each other. This determination may be performed by the processor 20, as described above.

In a step S500, the determined impact IMP on the product's PCF is output, e.g. via the output interface 30, as described above.

Further, the method may be modified in several ways as described above with regard to the system 1.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

1. A computer-implemented method for determining an impact of a difference between two production processes on a product carbon footprint, PCF, of a product produced using the production processes, the method comprising:
receiving first production process data comprising information about a first production process for a product;
receiving second production process data comprising information about a second production process different to the first production process;
determining, based on the first production process data, a first PCF of the product associated with producing the product using the first production process;
determining, based on the second production process data, a second PCF of the product associated with producing the product using the second production process;
determining the impact of the difference between the first and second production process by comparing the first and second PCF with each other; and
outputting the determined impact on the product's PCF.

2. The method of claim 1, wherein the method is carried out prior to an actual implementation of the second production process within a production planning phase.

3. The method of claim 1, wherein the second production process comprises an extension of the and/or a change in at least one production step compared to the first production process.

4. The method of claim 1, wherein the impact of the difference between the first and second production process on the product's PCF is output via a user interface.

5. The method of claim 1, wherein the second production process data is received via a user interface configured to allow the user, starting from the first production process, to make a change and/or extension to it to obtain the second production process data.

6. The method of claim 4, wherein the user interface is configured for providing the user with a selection of production process and/or product modifications as a blueprint or reference from which a change and/or extension to the first production process (PP1) can be selected to obtain the second production process data.

7. The method of claim 1, further comprising:
checking the first production process data and/or second production process data for consistency, particularly checking for a closed production chain.

8. The method of claim 7, further comprising:
adjusting the first production process data and/or second production process data based on the checking for consistency.

9. The method of claim 1, further comprising:
additionally comparing the second PCF to at least one reference PCF used as a PCF target value; and
adjusting the first production process data and/or second production process data based on the comparison with the at least one reference PCF.

10. The method of claim 1, further comprising:
determining a ratio between the difference between the first and second production process and an extend of production equipment adjustments associated with the difference between the first and second production process.

11. The method of claim 1, wherein the first PCF and/or second PCF is determined by:
receiving a carbon footprint of raw material used for producing the product;
receiving energy data comprising information about an energy consumption for each production process step; and
calculating the one first PCF and/or second PCF of the product taking into account the fist and/or second production process data, the carbon footprint of raw material and the energy data.

12. A method for monitoring and/or controlling production of a product comprising using an impact of a different between two production processes on a product carbon footprint of the product, wherein the impact is determined by the method of claim 1.

13. A non-transitory computer readable data medium storing a computer program including instructions for executing steps of the method according to a claim 1.

14. A system for determining an impact of a difference between two production processes on a product carbon footprint, PCF, of a product produced using the production process, the system comprising:
an input interface, configured to receive receiving first production process data comprising information about a first production process for a product and second production process data comprising information about a second production process different to the first production process;
a processor, configured to:
determine, based on the first production process data, a first PCF of the product associated with producing the product using the first production process;
determine, based on the second production process data, a second PCF of the product associated with producing the product using the second production process;
determine the impact of the difference between the first and second production process by comparing the first and second PCF with each other; and
an output interface, configured to output the determined impact on the product's PCF.

15. The system of claim 14, wherein the output interface comprises a user interface at least configured to display the determined impact on the product's PCF for further processing.

16. The method of claim 2, wherein the second production process comprises an extension of the and/or a change in at least one production step compared to the first production process.

17. The method of claim 5, wherein the user interface is configured for providing the user with a selection of production process and/or product modifications as a blueprint or reference from which a change and/or extension to the first production process can be selected to obtain the second production process data.
